(19) United States
(12) Patent Application Publication
(10) Pub. No.: US 2022/0393999 A1
(43) Pub. Date: Dec. 8, 2022

(54) MESSAGING SYSTEM WITH CAPABILITY TO EDIT SENT MESSAGES

(71) Applicant: Twitter, Inc., San Francisco, CA (US)

(72) Inventors: Jose Antonio MARQUEZ, San Francisco, CA (US); Chris Hawes, San Francisco, CA (US); Andy Schlaikjer, San Francisco, CA (US); Nick Morgan, San Francisco, CA (US); Rishi Renjith, San Francisco, CA (US); Leonardo Andres Garcia Crespo, San Francisco, CA (US); Runhang Li, San Francisco, CA (US); George Leontiev, San Francisco, CA (US); Matthew Gadda, San Francisco, CA (US); Steve Zimmerman, San Francisco, CA (US); Aigerim Dyussenova, San Francisco, CA (US); Lisa Ding, San Francisco, CA (US); Sol Plant, San Francisco, CA (US)

(21) Appl. No.: 17/832,478

(22) Filed: Jun. 3, 2022

Related U.S. Application Data
(60) Provisional application No. 63/327,782, filed on Apr. 5, 2022.
(60) Provisional application No. 63/196,647, filed on Jun. 3, 2021.
(60) Provisional application No. 63/196,630, filed on Jun. 3, 2021.

(51) Int. Cl. H04L 51/063; H04L 51/21; H04L 51/56; H04L 51/52

(52) U.S. Cl. CPC H04L 51/063; H04L 51/21; H04L 51/56; H04L 51/52

(57) ABSTRACT

An example social media messaging system may include a capability for a user to edit messages after the messages have been posted to the messaging system. The capability is implemented in a manner that preserves the immutability of messages that are posted to the messaging system.

### CROSS-REFERENCE TO RELATED APPLICATION(S)

This application claims priority to U.S. Provisional Application No. 63/327,782 filed Apr. 5, 2022, U.S. Provisional Application No. 63/196,647 filed Jun. 3, 2021, and U.S. Provisional Application No. 63/196,630 filed Jun. 3, 2021, the entire disclosure of each of which is herein incorporated by reference in its entirety.

### TECHNICAL FIELD

The disclosure relates to a messaging system, and more particularly to a capability for editing messages that have already been published in the messaging system.

### BACKGROUND

In a social media system, many users would like the ability and opportunity to change or edit messages posted to the system. For example, a user may, after having posted a message to the social media system, notice a typographical error in the messages or the content of the message may contain a factual error, and the user may desire to correct the error.

Messages posted to a social media system can be numerous and are almost instantaneously made accessible to numerous users and user devices. Moreover, messages posted by a user may be distributed or made available in another manner to other users in various formats. Also the messages can quickly be made available to users that do not belong to the group of initial recipients of such messages. The real-time or near real-time nature of social messaging systems, the large number of users accessing messages, the many formats in which messages are made available to users, almost instantaneous engagement with posted messages by other users, and like issues make the problem of editing already posted messages a challenging problem.

Users have previously handled their desire to correct the information such as typographical or other errors in their original posts using various techniques. In one example, a journalist on Twitter posted a message misattributing the reason that a well-known person was dismissed from a legal proceeding. The journalist later realized that the message is incorrect—but many of the journalist's followers on Twitter had already seen the message. In order to stop spreading the misinformation and correct it, the journalist deletes the message to stop people from viewing the incorrect information, posts a message again with the correct information, then replies to that message with a screenshot of the original deleted message so those who see the corrected one will have previous context.

In another example, a typical user of Twitter posts a message intended as a joke that a well-known person watches numerous hours of a particular television humor channel every day. Various users retweeted the message, not realizing it was a joke. The author lost control over the original message, with no way to reach everyone who had seen the message either directly or due to another user's forwarding of it. The author changes the username to “the humor channel thing is a joke” in hopes that users searching for the humor channel would see it and recognize that the original post is a joke.

In yet another example, a typical user sends a message in frustration about gun reform after a mass incident. Some of the user's followers misinterpret it and it goes viral, with people screenshotting and posting it on other social media forums. The user receives abusive messages, both on and off platform. The user Tweets multiple times to clarify the intended meaning, but the Tweet continues to be taken even further out of context and the user no longer has control over the conversation.

Techniques such as the above to correct posted messages can unnecessarily increase the processing overhead (e.g. by deleting and resending messages, repetitively sending correcting messages) of servers and/or client devices in the messaging system, may place an unduly heavy burden on users, and may also not yield a satisfactory solution to correcting the original post (e.g. copies of the original post being present in some instances). Therefore, improved solutions to editing of posted messages in social messaging systems are desired.

### BRIEF DESCRIPTION OF THE DRAWINGS

Aspects, features, and advantages of certain embodiments (i.e. examples) of the disclosure will be more apparent from the following description taken in conjunction with the accompanying drawings.

FIG. 1 illustrates an example online social messaging platform that provides an edit capability for already posted messages, according to some example embodiments.

FIG. 2 illustrates a message list that includes messages that have been edited being displayed on a client device, according to some example embodiments.

FIG. 3A illustrates a published message that contains a typographical error before being edited, according to some embodiments.

FIG. 3B illustrates an edit screen with a message being edited according to some example embodiments.

FIG. 3C illustrates the edit screen of FIG. 3B with an edit being made according to some embodiments.

FIG. 4A illustrates the message list of FIG. 2 after an edit to a message according some embodiments.

FIG. 4B illustrates the message list of FIG. 4A after a further edit to a message according some embodiments.

FIG. 5 illustrates a screen showing edit history of a message according to some embodiments.

FIGS. 6A, 6B, 6C and 6D illustrate updates to posted messages in various display surfaces according to some example embodiments.

FIG. 7 illustrates another example screen for displaying edit history according to some embodiments.

FIG. 8 illustrate a flowchart of a process performed by a client device in a messaging system of FIG. 1 to edit a message according to some embodiments.

FIG. 9A illustrates a flowchart of a process for creating the message data structure for an edited message according to some embodiments.

FIG. 9B illustrates a flowchart of a process for displaying editable status for messages according to some embodiments.

FIG. 9C illustrates a flowchart of a process for controlling the edit capability based on a timer according to some embodiments.

FIG. 9D illustrates a flowchart for a process for determining of the eligibility of a message to be edited according to some embodiments.

FIG. 10 illustrates a flowchart of a process for an edit capability by at least one server in a messaging system of FIG. 1 according to some embodiments.

FIG. 11 illustrates an example message data structure used for a message edit capability in a messaging system of FIG. 1 according to some embodiments.

FIG. 12 illustrates an example client device used in a messaging system of FIG. 1 according to some embodiments.

FIG. 13 illustrates a non-limiting, example block diagram for an example server in a messaging system of FIG. 1 according to some embodiments.

### DETAILED DESCRIPTION OF EXAMPLE EMBODIMENTS

Hereinafter, various embodiments (i.e. examples) of the disclosure may be described with reference to accompanying drawings. Accordingly, those of ordinary skill in the art will recognize that modifications, equivalents, and/or alternatives on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the disclosure, a first component may be referred to as a second component, and similarly, a second component may be referred to as a first component.

It will be understood that when a component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

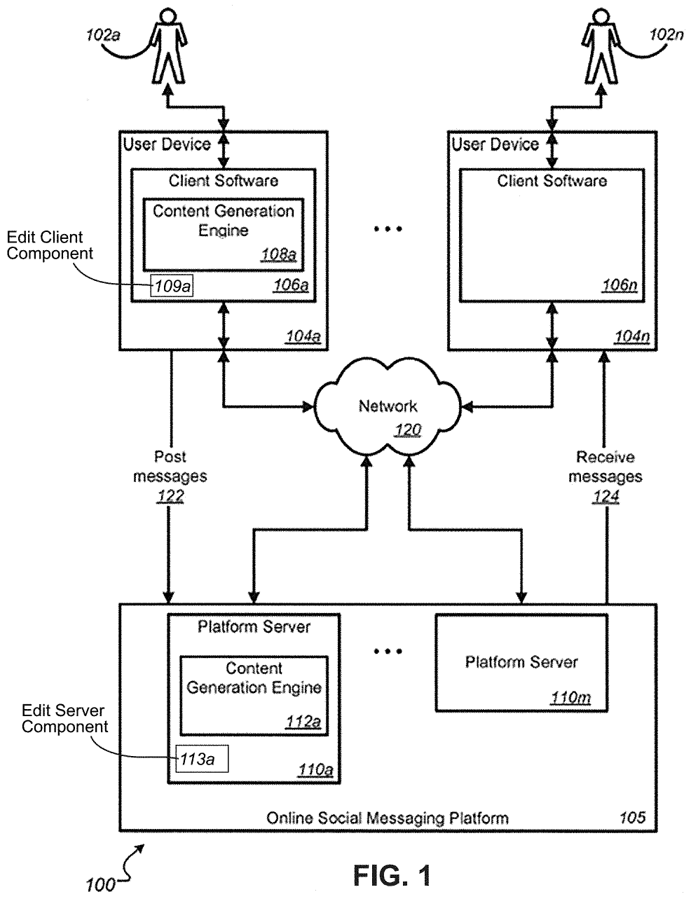

FIG. 1 illustrates an example online social messaging platform 100 and example user devices (also referred to as client devices) 104a-104n configured to interact with the platform over one or more data communication networks 120. The platform, the user devices, or both are configured, as will be described, to implement or perform the various technologies described in this application including message edit operations for posted messages.

The platform 100 is implemented on one or more servers 110a-110m. Each server is implemented on one or more computers, e.g., on a cluster of computers. Each server may include one or more modules for performing operations such as message delivery.

Users 102a-102n of the platform use user devices 104a-104n, on which client software 106a-106n is installed, to use the platform. Users can interact with the social messaging platform using the respective client software on their respective user devices. Among other things, the client software may include a message compose feature for composing messages to be sent to other users and an edit client component feature 109a for providing the capability for a user of the user device to edit messages that has been posted to the messaging platform and to receive edited messages and information relating to edited messages.

A user may be account holder of an account, or an authorized user of an account, on the platform. The platform may have millions of accounts of individuals, businesses, or other entities, e.g., pseudonym accounts, novelty accounts, and so on.

A user device 104 can be any Internet-connected device, e.g., a laptop or desktop computer, a smartphone, a wearable device such as a smart watch, or an electronic tablet. The user device can be connected to the Internet through a mobile network, through an Internet service provider (ISP), or otherwise.

Each user device is configured with software, which will be referred to as a client or as client software 106a-106n, that in operation can access the platform so that a user can post and receive messages, view and curate the user's message streams and message timelines, and view and interact with lists of content items. A timeline is a user interface presenting a stream of content items, e.g., messages, displayed in some order, e.g., the order in which they are posted or generated, with the most recent on top. As one of a user's timelines, a home timeline is a user interface that the user sees by default and that presents a stream of content items selected for the user and generally updated in real-time, for example, content from accounts the user has chosen to follow on the platform. As used herein, “timeline” is not intended to be limited to a strictly chronological ordering of messages and may, for example, be ordered based on time and relevance of messages to the interests of a particular user.

On any particular user device, the client may be a web browser or an HTML (hypertext markup language) document rendered by a web browser. The client may also be JavaScript code or Java code or the client may be dedicated software, e.g., an installed app or installed application designed to work specifically with the platform (e.g., an iOS or Android platform). The client may be or include a Short Messaging Service (SMS) interface, an instant messaging interface, an e-mail-based interface, or an API function-based interface, for example.

The social messaging platform 100 is implemented on one or more computers in one or more locations that operate as one or more servers that support connections over wired or wireless networks 120 from many different kinds of user devices. The platform may have many millions of accounts, and anywhere from hundreds of thousands to millions of connections may be established or in use between clients and the platform at any given moment.

The platform facilitates real-time communication or near real-time communication. The platform and client software are configured to enable users to use the platform to post messages 122 to the platform and to use the platform to receive messages 124 posted by other users. Among other things, the platform software may include an edit server component feature 113a for providing the capability for a user of the user device to edit messages that has been published to the messaging platform and to receive edited messages and information relating to edited messages.

In some implementations, the platform provides facilities for users to send messages directly to one or more other users of the platform, allowing the sender and recipients to maintain a private exchange of messages.

The platform is configured to provide content, generally messages, to a user in a home feed message stream or timeline. The messages will generally be messages from accounts or topics the user is following, meaning that the recipient has registered to receive messages posted by the followed account or related to followed topic, and optionally content that such accounts have engaged with, e.g., endorsed.

Optionally, the platform is configured to include in a recipient user's home timeline messages that the platform determines are likely to be of interest to the recipient, e.g., messages on topics of particular current interest, as represented by the number of messages posted on the topics platform users, or messages posted on the topics of apparent interest to the recipient, as represented by messages the recipient has posted or engaged with, as well as selected advertisements, public service announcements, promoted content, or the like.

The platform is configured to enable users to exchange messages in real-time, i.e., with a minimal delay. The platform is also configured to enable users to respond to messages posted earlier, on the order of hours or days or even longer. The platform is configured to display posted messages to one or more other users within a short time frame so as to facilitate what can essentially be a live conversation between the users.

Thus, the basic messaging functionality of the platform includes at least posting new messages, providing message streams on client request, managing accounts, managing connections between accounts, messages, and streams, and receiving engagement data from clients engaging with messages. The platform also indexes content items and access data and can provide the indexed data to account holders.

In some implementations of the platform, a message contains data representing content provided by the author of the message. The message may be a container data type storing the content data. The types of data that may be stored in a message include text, graphics, images, video, and computer code, e.g., uniform resource locators (URLs), for example. Messages can also include key phrases, e.g., hashtags that can aid in categorizing or relating messages to topics. Messages can also include metadata that may or may not be editable by the composing account holder, depending on the implementation. Examples of message metadata include a time and date of authorship and a geographical location of the user device when it submitted the message. In some implementations, what metadata is provided to the platform by a client is determined by privacy settings controlled by the user or the account holder.

Messages composed by one account holder may reference other accounts, other messages, or both. For example, a message may be composed in reply to another message composed by another account. A message may also be composed by a user in reply to a message originally posted by the user. Messages may also be republications of a message composed by and received from another account. Generally, an account referenced in a message may appear as visible content in the message, e.g., the name of the account, and may also appear as metadata in the message. As a result, the referenced accounts can be interactive in the platform. For example, users may interact with account names that appear in their message stream to navigate to the message streams of those accounts. The platform also allows messages to be private; a private message will only appear in the message streams of the composing and recipient accounts.

In some implementations, messages are microblog posts, which differ from e-mail messages, for example, in that an author of a microblog post does not necessarily need to specify, or even know, who the recipients of the message will be.

A stream is a stream of messages on the platform that meet one or more stream criteria. A stream can be defined by the stream criteria to include messages posted by one or more accounts. For example, the contents of a stream for a requesting account holder may include one or more of (i) messages composed by that account holder, (ii) messages composed by the other accounts that the requested account holder follows, (iii) messages authored by other accounts that reference the requested account holder, or (iv) messages sponsored by third parties for inclusion in the account holder's message stream. The messages of a stream may be ordered chronologically by time and date of authorship, or reverse chronologically. Streams may also be ordered in other ways, e.g., according to a computationally predicted relevance to the account holder, or according to some combination of time and relevance score.

A stream may potentially include a large number of messages. For both processing efficiency and the requesting account holder's viewing convenience, the platform generally identifies a subset of messages meeting the stream criteria to send to a requesting client once the stream is generated. The remainder of the messages in the stream are maintained in a stream repository and can be accessed upon client request.

Accounts will in general have relationships with other accounts on the platform. Relationships between accounts of the platform are represented by connection data maintained by the platform, e.g., in the form of data representing one or more connection graphs. The connection data may be maintained in a connection repository. A connection graph includes nodes representing accounts of the platform and edges connecting the nodes according to the respective relationships between the entities represented by the nodes. A relationship may be any kind of association between accounts, e.g., a following, friending, subscribing, tracking, liking, tagging, or other relationship. The edges of the connection graph may be directed or undirected based on the type of relationship.

In some example embodiments, the platform tracks engagement with messages. For example, the platform may maintain, in a message repository, data that describes each message as well as the engagement with each message.

Engagement data can include any type of information describing user activity related to a message by an engaging account of the platform. Examples of engagement by a user include, for example, reposting the message, marking the message to indicate is a favorite of, liked by, or endorsed by the user, responding to the message, and mentioning or referencing the message. Engagement data may also include how many followers, connections, and/or friends of the context account have connections with the engaging account, e.g., are in a connection graph of the engaging account, or an indication that the context account is a favorite account of the engaging account.

Engagement data can also include any type of information describing activity related to a context account by an engaging account of the platform. A context account is any account that a user, i.e., the engaging account, is engaging with. And engagement data relating to a context account can be data about engagement activity of that account or engagement activity by others with that account.

The servers of the platform perform a number of different services that are implemented by software installed and running on the servers. The services will be described as being performed by software modules. In some cases, particular servers may be dedicated to performing one or a few particular services and only have installed those components of the software modules needed for the particular services. Some, modules will generally be installed on most or all of the non-special-purpose servers of the platform. The software of each module may be implemented in any convenient form, and parts of a module may be distributed across multiple computers so that the operations of the module are performed by multiple computers running software performing the operations in cooperation with each other. In some implementations, some of the operations of a module are performed by special-purpose hardware.

In some implementations, the platform includes numerous different but functionally equivalent front end servers, which are dedicated to managing network connections with remote clients.

The front end servers provide a variety of interfaces for interacting with different types of clients. For example, when a web browser accesses the platform, a web interface module in the front end module provides the client access. Similarly, when a client calls an API made available by the platform for such a purpose, an API interface provides the client access.

The front end servers are configured to communicate with other servers of the platform, which carry out the bulk of the computational processing performed by the platform as a whole.

A routing module stores newly composed messages in a message repository. The routing module also stores an identifier for each message. The identifier is used to identify a message that is to be included in a stream. This allows the message to be stored only once and accessed for a variety of different streams without needing to store more than one copy of the message.

A graph module manages connections between accounts. Connections determine which streams include messages from which accounts. In some implementations, the platform uses unidirectional connections between accounts and streams to allow account holders to subscribe to the message streams of other accounts. A unidirectional connection does not necessarily imply any sort of reciprocal relationship. An account holder who establishes a unidirectional connection to receive another account's message stream may be referred to as a “follower,” and the act of creating the unidirectional connection is referred to as “following” another account.

The graph module receives client requests to create and delete unidirectional connections between accounts. In some implementations, these connections are stored in a relationship repository as part of a unidirectional connection graph. Each connection in the connection graph repository references an account in the account repository or a stream in the stream repository.

In the same or a different embodiment, the graph module can provide and manage bidirectional connections. In a bidirectional connection, both accounts are considered subscribed to each other's account message streams. The graph module stores bidirectional connections in the relationship repository. In some implementations, the platform and connection graph repository include both unidirectional and bidirectional connections.

A delivery module constructs message streams and provides them to requesting clients, for example, through a front end server. Responding to a request for a stream, the delivery module either constructs the stream in real time, or accesses from a stream repository some or all of a stream that has already been generated. The delivery module stores generated streams in the stream repository. An account holder may request any of their own streams, or the streams of any other account that they are permitted to access based on security settings. If a stream includes a large number of messages, the delivery module generally identifies a subset of the messages to send to a requesting client, in which case the remainder of the messages are maintained in a stream repository and sent upon client request.

An account module enable account holders to manage their platform accounts. The account module allows an account holder to manage privacy and security settings, and their connections to other account holders. The account module may store information about users of the platform such as an account name, which is not necessarily a real name, an identifier, a user name, a picture, a brief description of themselves or the entity, an e-mail address, and a website. Information about each account is stored in an account repository.

Client software allows account holders receiving a stream to engage, e.g., interact with, comment on, or repost, the messages in the stream. An engagement module receives these engagements and stores them in an engagement repository. Types of engagement include selecting a message for more information regarding the message, selecting a URI (universal resource identifier) or hashtag in a message, reposting the message, or making a message a favorite. Other example engagements types include opening a “card” attached to message, which presents additional content that is a target of a link in the message, or links to an application installed on the user device. Account holders may engage further with the additional content, e.g., by playing a video or audio file or by voting in a poll.

In addition to recording active interactions with messages through explicitly received user device input, the engagement module may also record passive interactions with messages. An impression occurs when a client presents the content of a message on a user device. Impression engagements include the mere fact that an impression occurred, as well as other information, e.g., whether a message in a stream appeared on a display of the user device, and how long the message appeared on the display. Any engagement stored in the engagement repository may reference the messages, accounts, and/or stream involved in the engagement.

Engagements may also be categorized beyond their type. Example categories include engagements expressing a positive sentiment about a message (“positive engagements”), engagements expressing a negative sentiment about a message (“negative engagements”), engagements that allow an advertiser account to receive monetary compensation (“monetizable engagements”), engagements that are expected to result in additional future engagements (“performance engagements”), or connection engagements that are likely to result in one account holder following another account (“connection engagements”). The negative engagements category includes, for example, engagements dismissing a message or reporting a message as offensive while the positive engagements category typically includes engagements not in the negative engagements category. Example performance engagements include selecting a URL (uniform resource locator) in a message or expanding a card. Example monetizable engagements include, for example, engagements that result in an eventual purchase or a software application install on a user device. Generally, categories and types are not coextensive; a given type of engagement may fall into more than one category and vice versa.

Users of a messaging system such as that shown in FIG. 1 sometimes desire to edit an already sent (i.e., a posted message) message. This desire can arise from noticing one or more typographical errors in the message content. A user may also desire to edit a message upon realizing that some content (e.g., an attachment) is not included or that some additional information or further explanation should be included in the message content (e.g., a further explanatory sentence). The user may realize a better way to express the thoughts in the message using different language. In other instances, the user may identify a factual error in the message or that some intended recipient is omitted or an unintended recipient included.

There is a need for an in-product edit solution in a messaging system, such as, for example, the messaging system 100, to provide the tools to message authors who either make unintentional errors or unintentionally spread misinformation. Embodiments of this application provide users of the messaging system who are authors of messages a way to correct or clarify their messages, thereby helping the messaging system in increasing the accuracy of the posted messages and reducing the spread of incorrect information. In some embodiments, in addition to the author of a message, other users authorized by the author and/or the messaging system may be provided with the capability to correct or clarify the message.

Users who may find such a capability useful may belong to many types: Newsrooms sometimes unintentionally post factually incorrect information (e.g., a journalist may get the name of a suspect wrong and need to make a correction); ordinary users may find that their posts (e.g. posted/published messages) are taken out of context and are misinterpreted by the larger user population, etc.); a parody account may make a joke that's shared out seriously and needs to clarify that (e.g., but the post may have already been amplified throughout the messaging platform beyond the reach of the original author's followers, for example, through ReTweets, QuoteTweets, DMs, iMessage, syndication, etc.); and regular users of the messaging platform may want to correct faulty information to uphold their perceived credibility.

Example embodiments provide the capabilities to at least (1) reduce prevalence of posts (e.g. posted messages) that contain typographical or factual errors in the messaging system, and (2) provide more context on posts so users (i.e. consumers of the posts) can make more informed assessments. Moreover, by providing a more efficient mechanism to edit messages and thereby avoiding the substantial processing overhead of various previous techniques for correcting posted messages, example embodiments may improve processing capacity and performance (e.g., messages processed in a time interval, processing speed for messages, etc.) of the messaging system.

Some example embodiments provide the capability for all users, or only authorized users, to issue edits of a posted message such that the content of the editing message (i.e., the message that includes the edits or clarifications of the previous message) and the edited message (also referred to as “stale message”, e.g., the message with the error that is edited or clarified by the editing message) is clearly associated with each other and made available to users in association with each other. By this technique, when a message subsequent to an edit is presented to users on any of several presentation formats available in the messaging system, the edited message is always clearly associated with the editing message, thereby efficiently and consistently conveying the edit status of messages to all users consuming the messages while also reducing the need for duplicate messages and the like to be transmitted as required by some conventional techniques. Although editing a message may most often be to make changes to the text of the message, some embodiments provide for making changes (e.g., add or remove) media and/or other tangibles that are made available as part of the message.

In example embodiments, an “editing message” is a separate standalone message with its own unique message identifier and message data structure that is separate from the message data structure of the edited message. For example, on Twitter, an editing message may have its own Tweet ID that is different from the edited message's Tweet ID. When a message is edited, some new metadata may be added to the message data structure corresponding to the edited message pointing to the editing message. For example, on Twitter, when a message is edited, the edited message will get new metadata pointing to the editing message.

The following terminology may be used in the description below. “Initial message” refers to the initial version of a post. The message may be a normal message (e.g., a tweet), a reply, a quote post (e.g., a quote tweet), etc. “Editing message” refers to a new version of a message. An “initial message” may have zero or more editing messages. “Latest message” refers to a message which represents the latest version of an initial message. If an initial message has no associated edited messages, then it is itself a latest message. “Previous message” refers to the previous version of a message, if any. Previous message is undefined for an initial message. “Stale message” refers to an initial or subsequent message for which a newer version exists.

Subsequent to an edit being performed, when certain user devices of the messaging system are served the edited messages and/or when the edited messages are fetched by clients on the user devices, the message content of an edited message in a list of messages (a “message list”) may be provided with a user interface object (such as a selectable link) that represents the corresponding editing message. If the user interface object is selected by the user, the editing message is shown.

In some example embodiments, if a user clicks on an edited message displayed in a message list, the user may be provided with the message details of the edited message, where there may be a user interface object with a link to the corresponding editing message located above (or anywhere close to) the edited message. This user interface object may inform the user that an edit has been issued, so that the user sees it before reading the later-edited information.

In some example embodiments, if a user clicks on the editing message within message detail, both the editing message and the edited message may be made visible to the user. There may be a user interface object in close proximity to the edited message that informs the user that the focal message (e.g., the current message) is an editing message.

In example embodiments, various types of attachments such as, for example, media, polls, cards, quoted posts, etc. may be edited. In some embodiments, only text may be edited (e.g., editing of links, media etc. may be disallowed). In some embodiments, handles (e.g., @-mentions) may be added or removed from the body of the message. In some embodiments, messages including polls and/or links to polls, forwarded messages, etc. may be prevented from being edited.

A user who has authored a message may be provided with an option to issue an edit of that post. In some embodiments, this option may be provided as one of a plurality of menu options. In some embodiments, only select authors (e.g. based on author's privilege/subscription level) may be provided the edit capability based on a permission being selectively enabled or by a whitelisting mechanism. A user may be provided with a message compose capability to generate the editing message. On Twitter, for example, a capability similar to the Tweet compose capability may be provided for generating the editing tweets.

After the editing message has been composed, the user may be provided with the capability to either post or cancel the composed editing message. The user (i.e. the author of the post or a user with certain assigned privileges) may be enabled to delete (cancel) the composed editing message. In some embodiments, if an editing message is deleted by the author after it is posted, the corresponding one or more edited messages may also be deleted automatically. In some embodiments, deleting an edited message may also cause the corresponding editing message to be deleted.

A consuming/receiving user may see any posts, including editing messages, in a message list that is served to, or obtained by, the user. In some embodiments, a receiving user may see the edited message in the message detail (or message body) area of the editing message. For example, in Twitter, a receiver user may see any editing tweets in Tweet Detail with the edited tweet visible within an inset area. There may also be a user interface element that identifies the editing message as a more recent version of the edited message. In some embodiments, a message list may contain the editing message and also the edited message as respective messages, but the edited message may have text or a user interface element indicating that it is an edited message.

In some embodiments, users can engage with an edited message or an editing message just as any other message that is not edit-related. Users may be warned each time they attempt to engage (e.g. to repost, to forward, to like, to comment etc.) with an edited message, that the message has a newer version. In some embodiments, the messaging system may disable users' ability to engage with edited messages.

In some embodiments, upon a message being edited, notification of the edit may be proactively provided (e.g., pushed) to certain users. For example, the messaging system may proactively push edits made to messages where the corresponding messages have been embedded in another user application (e.g., newspaper article that has an embedded message served by the messaging platform 100) to provide the user application with the capability to either replace the embedded message with the editing message or to annotate the embedded message with an indication that it is an edited message and a new version is available.

In some embodiments, upon a message being edited, copies of the message that are cached on client devices may be updated with interstitials.

In some embodiments, the editing capability may be restricted to a time interval measured from the message's origination. For example, the edit capability may be only available for a configured time period (e.g. 30 minutes, 1 day, etc.) after the posting of the message to the messaging system.

In some embodiments, in addition to or as an alternative to time-based restrictions on editing, a message may be edited only up to a configured number of times. For example, a message may be edited, but the edited message may not be edited again.

In some embodiments, various types of posts may be permitted to be edited. For example, on Twitter, tweets, replies, quote tweets, etc. may be edited. In some embodiments, selected types of messages may not be permitted to be edited.

In some embodiments, the messaging system provides the capability for users (authors and other users) to view the revision history of a message, and/or if desired, to view the original (now edited) message.

In some embodiments, engagements with a message may be carried over to the editing message when that message is edited. For example, on Twitter, if the edit happens sometime after the original message is modified, ideally engagement counts (e.g., the number of likes, retweets, replies, etc. and/or their sum) from the original message are rolled over to the new message (editing message). Also, retweeted or quote-tweeted references to the original message are updated to point to the new message. It is noted that such carryover of engagements should be handled with appropriate precautions taken to address possible abuse (e.g. bait and switch using certain posts) of the edit feature.

In some embodiments, when a message that is the root of a conversation tree (e.g. tree with a root node message that has a plurality of replies and corresponding sub branches) is edited, the conversation tree may remain unchanged in its tree structure.

The systems and methods of the example embodiments were chosen as a primary implementation of the edit capability for posted messages after the evaluation of several other alternatives. One alternative editing technique is referred to as post recreation. In post recreation, the original message is transparently deleted and replaced with the edited message. After the user completes their edit, the client issues a deletion of the original message, and then creates a new message with the edited state. This approach may have shortcomings that include users or clients who have the original message rendered not loading updated text for the message, having no ability to link from original message to the editing message, embedded messages which subsequently get edited become broken (e.g., retweets and quote tweets of original tweet are broken, conversation trees become broken), not having revision history, and having no engagement carried forward (e.g., engagement on original message is lost).

Another evaluated alternative edit technique is literal edit. In this technique, the underlying message is modified. For example, text entities, such as mentions, from the new message text is extracted, the underlying message is loaded, the text and associated entity fields are replaced, and is written back. After the edit to the post, the post cache is flushed and new post data is reloaded, followed by publishing. Shortcomings of this technique may include users or clients who have the original message rendered not loading updated text for the message, inconsistent experience across products where some products may make the assumption that posts are immutable.

Self-reply is another evaluated alternative technique to perform edits, where the author replies to their own message having an error with a reply message that includes the correction. Shortcomings of this technique may include that the original errored message is still available to be engaged by other users in its original errored form.

Providing for consumption of messages may include adding labeling views to all forms of messages that may exist informing the user if the message is an editing (i.e. current) message or an edited (i.e. stale) message, as well as adding timelines to show historical engagements and the edit history of a message. The edit history can be considered as providing the function of a “paper trail” for a message since, for example, it shows each version of the evolution of a message from the initial version to the current version. These capabilities may require clients to get or, be provided with, the edited status and the message lists from the servers of the messaging system. Along with this there may be a need for additional filtering (one or both server-side visibility filtering and client-side visibility filtering) to remove old content from message lists in order to show the most up to date content to the user.

In some embodiments, new engagements and replies may not be allowed on stale messages, however, aggregate engagement counts may be applied to the associated editing/current version. Likes may be aggregated at read time. Each post in the edit chain may be configured to maintain a separate engagement count. Also, in some embodiments, stale messages may not be deleted directly, but editing/current message deletions may cascade to (i.e. cause the deletion of) associated stale messages.

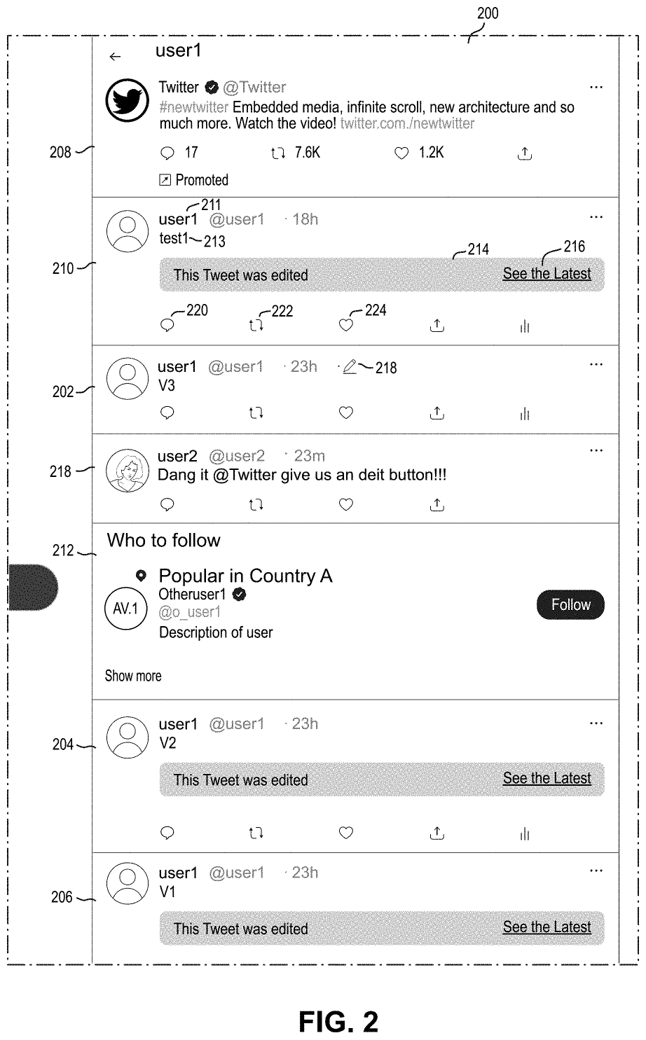

FIG. 2 illustrates a message list 200 that includes edited messages being displayed on a client device in a scrollable manner showing a portion of message list 200, according to some example embodiments. In an example embodiment, the message list 200 is a timeline for a particular user. The message list 200 may have been generated for the user user1 by at least one server of the messaging system 100 based on, for example, the user's message stream, and may include messages posted by user user1 and messages posted by other users of the messaging system. The messages included in the message list 200 may be messages that the system determines are of most interest to user1. The messages of most interest to user1 may be determined by the system based on user1 configured preferences, messages posted or engaged with by other accounts with which user1 engages, and/or other messages with which user1 has engaged. The message list 200 may include any combination of messages that cannot be edited, messages that can be edited, editing messages, and edited messages. In an example embodiment, edited messages are associated with an indicator representing that they have been edited. Additionally, in example embodiments, messages that are edit-eligible may be indicated as such.

Messages 202, 204 and 206 are, for example, three versions of a message. Message 206 is the initial version (initial message). Message 206 is edited to obtain message 204, the second version (edited message). Message 204 is edited by user1 to obtain message 202 which is the most current version (editing message). Messages 204 and 206, having been edited, have an indicator displayed that indicates that the message has been edited and provides a manner (e.g. a clickable link) in which to view the latest message.

Message 208 is a promoted message included in the message list 200. Message 208 has not been edited and it is not eligible to be edited by user1 at least because user1 is not the author of the message. Message 212 is another type of message promoting a particular account to be followed by user1.

Message 210 is a message authored by user1 but which has been edited thus creating a new version. The new version is not visible in the visible portion of the message list as shown in FIG. 2.

Since message 210, the body 213 of which is “test1”, has been edited, the indicator 214 indicates that the message has been edited and provides a link 216 for the user of the client device to access the latest version for edited message 210.

Each message in message list 200 may be displayed with one or more indicators of engagements, for example, such as indicators to reply 220, forward 222, and like 224.

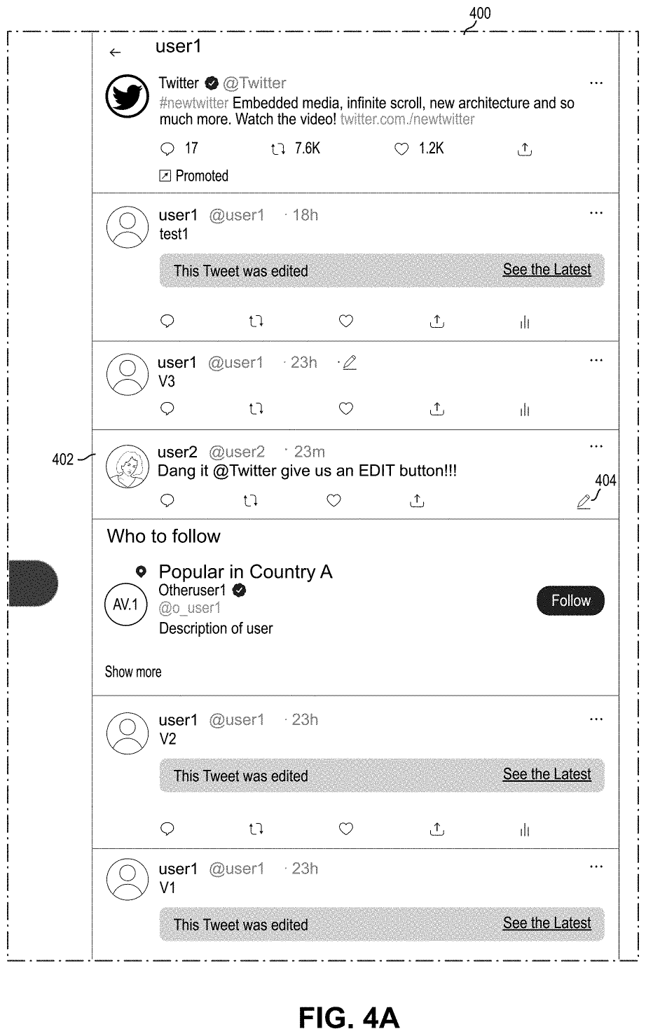

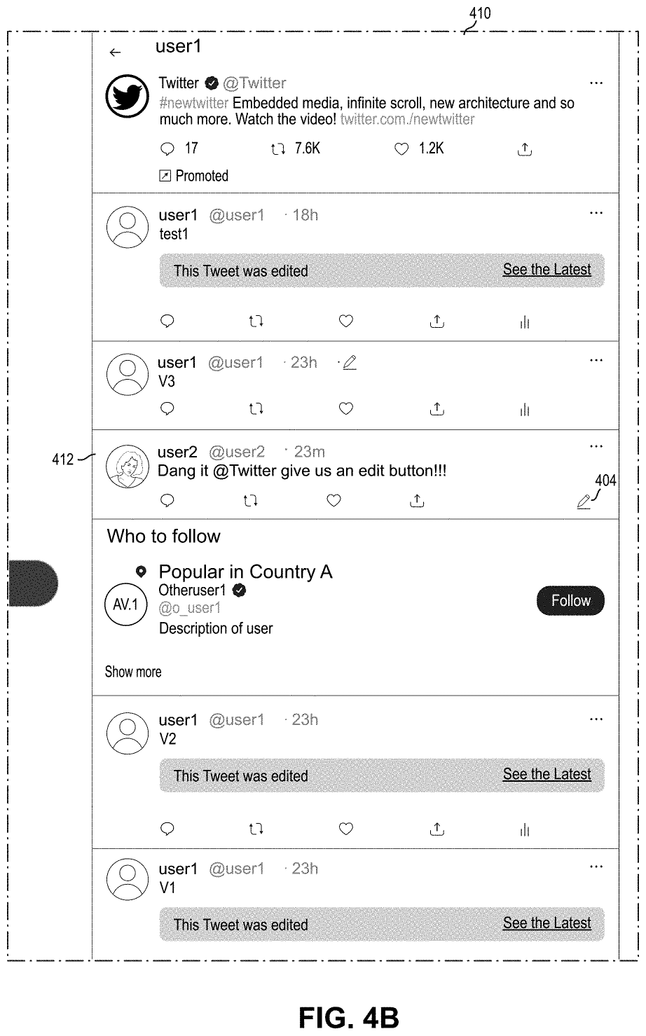

Message 218 is authored by user user2 and contains a typographical error. FIGS. 4A and 4B illustrate how the message is shown in the message list of user1, as user2 edits the message.

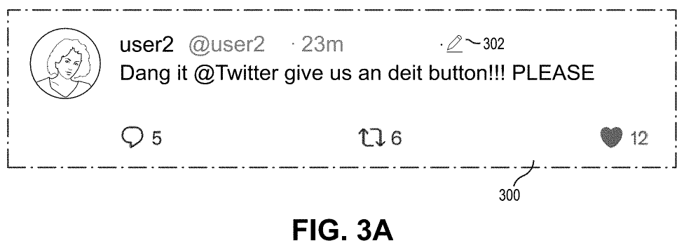

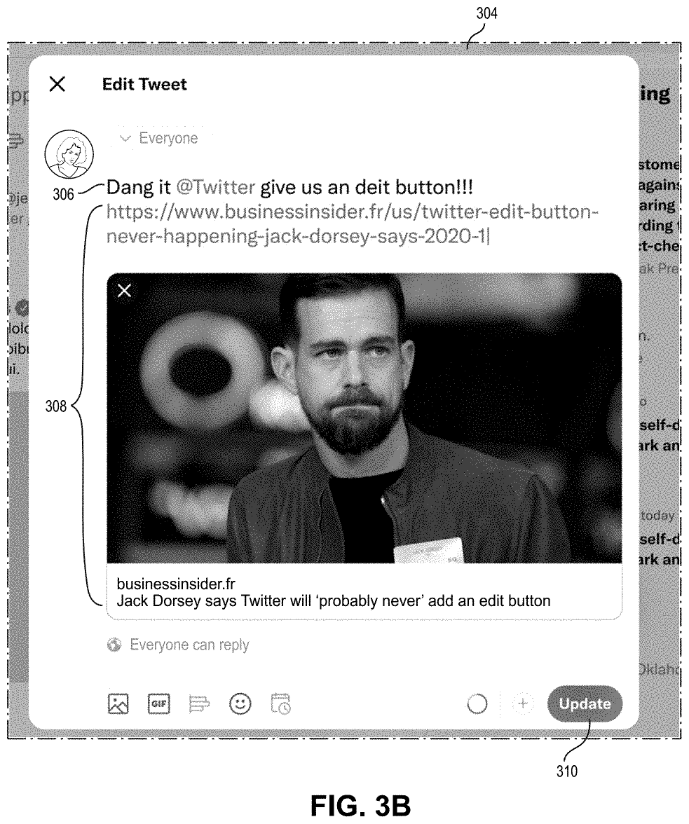

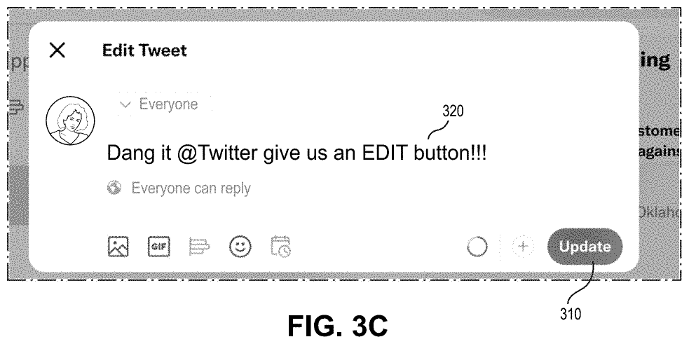

FIG. 3A illustrates a published message 300 that contains a typographical error before being edited, according to some embodiments. Message 300 is shown as it would be seen by user2. An edit indicator 302, indicating that the message is currently editable, may be displayed to user2. Time elapsed since the message was posted/published to the messaging system may also be displayed in association with the message.

FIG. 3B illustrates an edit screen 304 with the message 300 being edited by user2 according to some example embodiments. For example, edit screen 304 may be presented when user2 selects the edit indicator 302 associated with message 300 (e.g., touches, mouse clicks on the edit indicator 302 for message 300) in a message list displayed on a user device.

The edit screen 304 may, when invoked by selecting the edit indicator 302, by default copy the body 306 of message 300 that is to be edited to the edit screen so that user2 may perform the edit more efficiently. User2 may include any text, or include any attachment (e.g., link to article 308) in performing the edit. Other aspects of message 300, such as the target recipients and/or group of users allowed to reply to message 300, may also be copied to the new message and permitted to be modified.

The edit screen may include a button 310 for the user to submit the edits to complete the editing of message 300. In example embodiments, button 310 may be named “update” or the like to clearly distinguish from a “send” or like button that is used in performing initial composition of messages.

FIG. 3C illustrates the edit screen of FIG. 3B with an edit 320 being made according to some embodiments. Specifically, FIG. 3B shows the message body shown in FIG. 3A after the word “deit” (i.e. the typographical error intended to be corrected using the edit feature) to “EDIT” and the attachment 308 having been removed.

FIG. 4A illustrates the message list 400 of FIG. 2 after an edit to a message according some embodiments. For example, message list 400 may be what is seen by user1 after user2 has completed the edit shown in FIG. 3C by pressing the “update” button shown in FIG. 3C. The latest version 402 of message 300 is shown with an indicator 404 indicating that the message 402 is an editing message, that is, an edited version of a previous posted message.

FIG. 4B illustrates the message list of FIG. 4A after a further edit to a message according some embodiments. Message list 410 may be what is seen by user1 when user2 performs a further edit of the message shown in FIG. 3C by, again invoking an edit screen, changing the word “EDIT” in the message to “edit” and submitting that edit to be posted. As in message list 400, message list 410 also shows the user2 editing message 412 with the edited indicator 404.

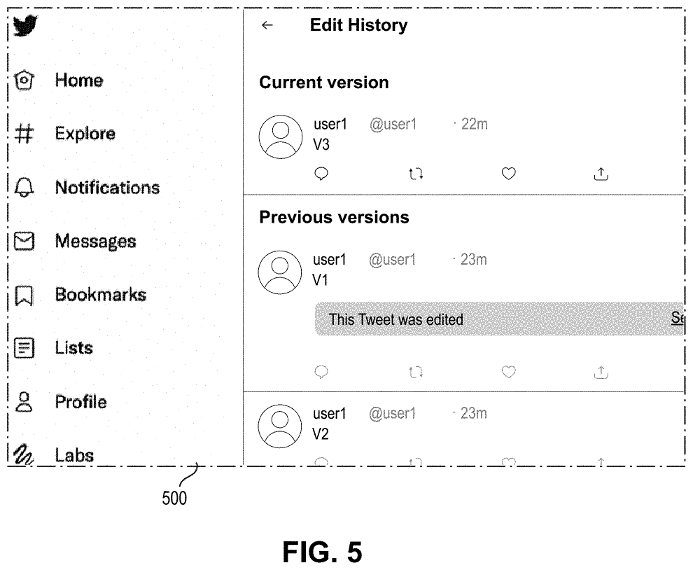

FIG. 5 illustrates a screen 500 showing the edit history of a message according to some embodiments. For example, screen 500 may be presented to user1 or any other user of the messaging system who has received any of the messages 202, 204 or 206. A user may be presented screen 500 when the user selects to view the edit history of any of the messages 202, 204 or 206 by, for example, selecting one of the messages 202, 204 or 206 in a message list or upon further selecting from a menu of options to view the edit history. The edit history shows each version of the message in the chain of edited messages.

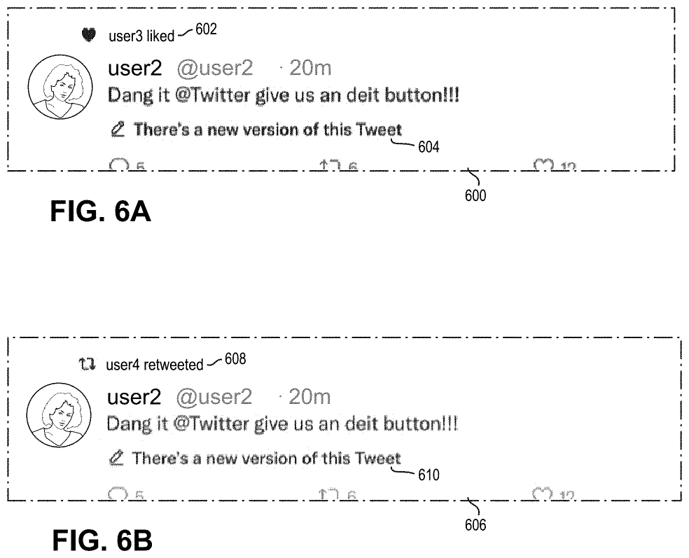

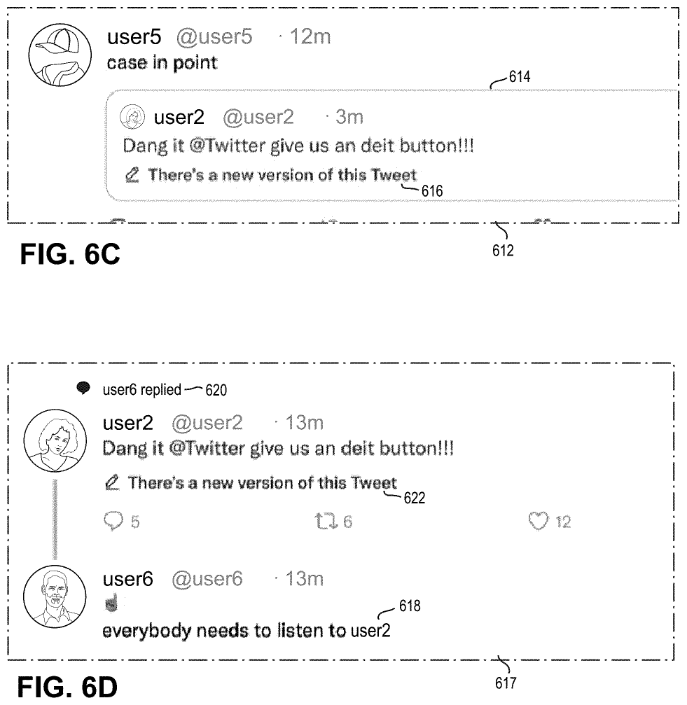

FIGS. 6A, 6B, 6C and 6D illustrate updates to posted messages being displayed in association with different types of messages that appear in message lists displayed on user devices, according to some embodiments.

FIG. 6A illustrates the message 300 as it would be displayed on a user device for a user A whose message list includes message 300 because user3 with whom user A is associated by the messaging system engages with message 300 by “liking” message 300. Item 600 displayed on user A's user device includes message 300 and an indicator 604 that the message has been edited. In some embodiments, user A may select the indicator 604 to view the latest version of message 300 and/or its edit history. Item 600 may also include the reason 602 (here, that user3 engaged with a “like” engagement of message 300) as to why message 300 is included in the message list for user A.

FIG. 6B illustrates the message 300 as it would be displayed on a user device for a user B whose message list includes message 300 because user4 with whom user B is associated by the messaging system engages with message 300 by “retweeting” or republishing message 300. Item 606 displayed on user A's user device includes message 300 and an indicator 610 that the message has been edited. In some embodiments, user A may select the indicator 610 to view the latest version of message 300 and/or its edit history. Item 606 may also include the reason 608 (here, that user4 engaged with a “retweet” engagement of message 300) as to why message 300 is included in the message list for user B.

FIG. 6C illustrates the message 300 as it would be displayed on a user device for a user C whose message list includes message 300 because user5 with whom user C is associated by the messaging system engages with message 300 by quoting message 300 in another message. Item 612 displayed on user B's user device includes message 300 and an indicator 616 that the message has been edited. In some embodiments, user C may select the indicator 616 to view the latest version of message 300 and/or its edit history. Item 612 may also include the message 300 as a quote 614.

FIG. 6D illustrates the message 300 as it would be displayed on a user device for a user D whose message list includes message 300 because user6 with whom user D is associated by the messaging system engages with message 300 by replying to message 300. Item 617 displayed on user D's user device includes message 300 and an indicator 622 that the message has been edited. In some embodiments, user D may select the indicator 622 to view the latest version of message 300 and/or its edit history. Item 617 may also include the reason 620 (here, that user6 engaged with a reply of message 300) as to why message 300 is included in the message list for user D.

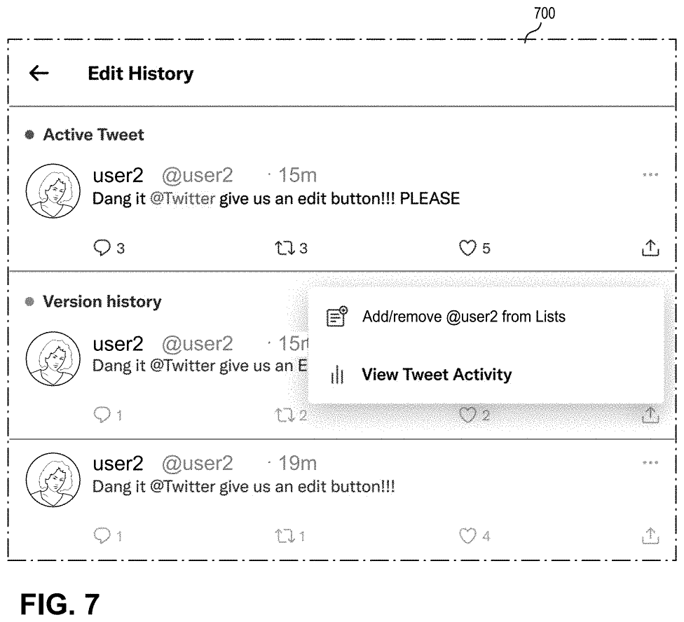

FIG. 7 illustrates another example screen for displaying edit history according to some embodiments. Edit history screen 700 shows the currently active version of the message, and each of the previous versions arranged in the order or origination time. The user is enabled to select any one of the versions to view details of engagement activity with each version.

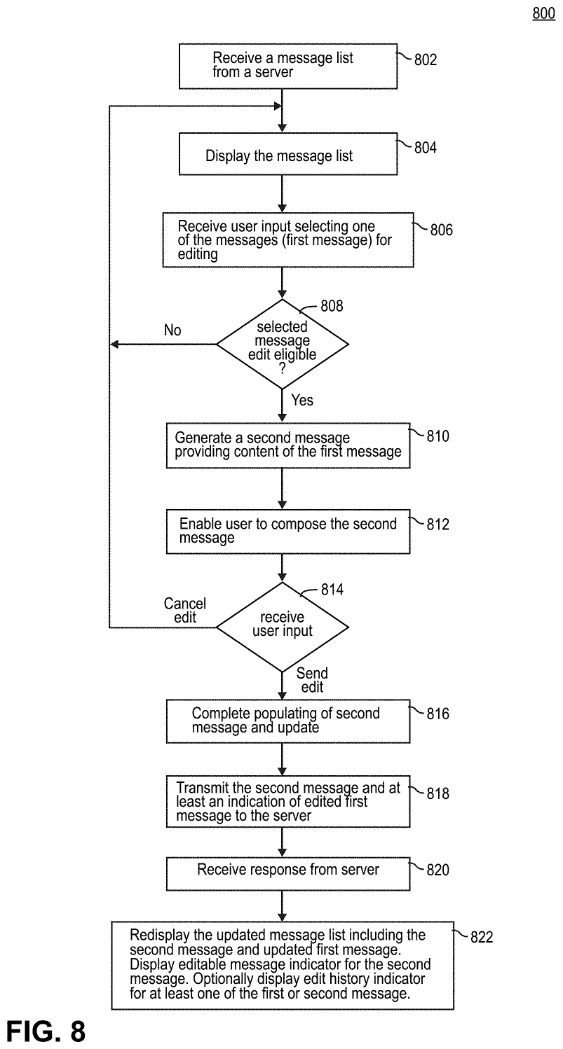

FIG. 8 illustrates a flowchart of a process 800 performed by a user device in a messaging system of FIG. 1 to edit a message according to some embodiments. According to an embodiment, process 800 may be performed by a user device such as user device 104a in the messaging system, using, for example, client software 106a and edit client component 109a. In some embodiments, one or more operations 802-822 may not be performed, or may be performed in an order different from the illustrated order.

At operation 802, the user device receives a message list from a server of the messaging system. For example, in the messaging system 100, a user device 104 (e.g., user device 104a) may receive a message list of a plurality of messages from a server (e.g. platform server 110a) of the online social messaging platform 105. The message list includes a plurality of messages that may have been each selected by a server (e.g., server 110a and content generation engine 112a) of the messaging system for inclusion in the message list to be sent to the user of the user device based upon one or more of configured preferences of the user, for example, but not limited to, preferences of the user that are dynamically determined by the messaging system based on the user's engagement with messages served by the platform and/or with other users of the messaging system, a type of message (e.g. advertising, promoted message, service message), or one or more characteristic (e.g., geographic location) of the user. In some embodiments, the message list is generated by the server based on message stream assigned to, or associated with, the user. The message list includes messages sent by other users and may include messages sent by the user.

In some embodiments, the message list is referred to as a timeline, and comprises a plurality of messages arranged in order of the respective message posted times. The timeline, such as the timeline 200 shown in FIG. 2, includes messages posted by the user, messages posted or engaged with by other users who have a determinable relationship (e.g., a follow relationship), promoted messages and other messages that are determined by the messaging system to be of likely interest to the user.

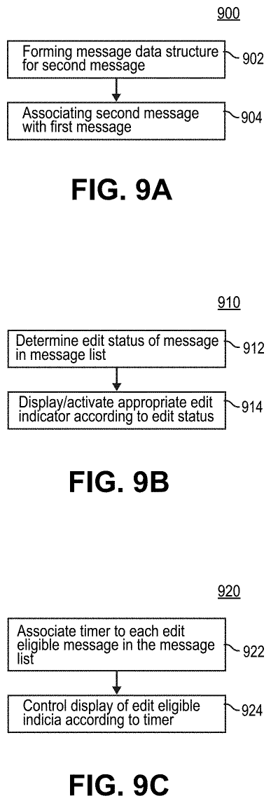

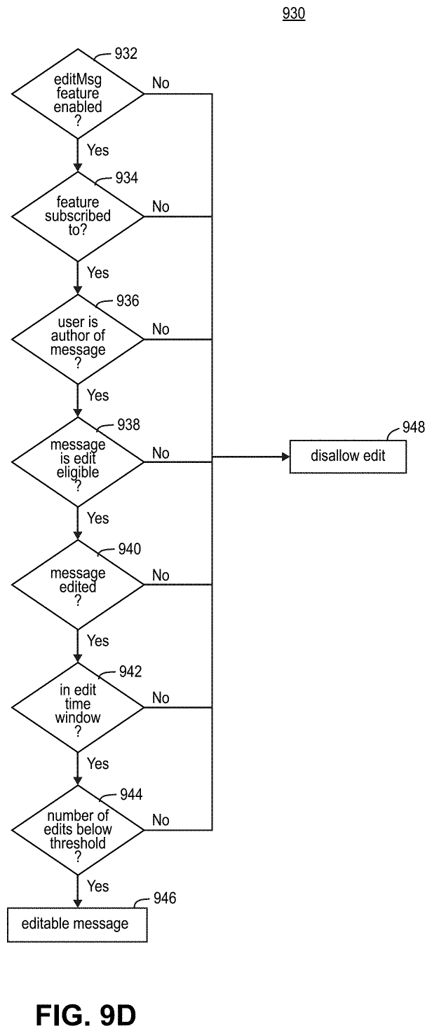

At operation 804, the message list is displayed on the user device. FIG. 2, for example, illustrates an example displaying of a message list on a user device. One or more messages in the message list may include a visual indicator 218 that indicates that they are editable and/or have been edited. In some embodiments, the visual indicator indicating that a message is editable is displayed only for messages for which the validation process 930 to determine editability of the message is completed. In some other embodiments, the visual indicator indicating that a message is editable is displayed for messages if the user has sufficient privileges to edit messages, if the edit time window has not expired for the message, and the message is not an edited message. In some embodiments, a message's eligibility for editing may be determined based on any one or more of the tests shown in FIG. 9D. In some embodiments, where the available screen space is not sufficient to display all elements such as a message author name, author handle, author status, edit indicator etc., the edit indicator 218 may have priority to be displayed in the available screen space.

At operation 806, the user selects a message in the message list for editing. The selection may be made by a user input such as touch, mouse click, etc.

At operation 808, a determination is made as to whether the selected message is eligible to be edited. This determination may be based on whether the user who selects the message is authorized to edit the message and/or whether the current time is within a predetermined edit time window from the time that the selected message was posted. In one embodiment, only the author of the message is authorized to edit the message. In some embodiments, a message may be edited only up to a predetermined number of times. FIG. 9D illustrates a process that can be used to determine whether the selected message is eligible to be edited, according to some embodiments. In some embodiments, the selected message may be deemed eligible for editing if one or more of the tests shown in FIG. 9D is satisfied by the selected message.

If the determination at operation 808 determines that the message is not eligible to be edited, the edit process is terminated, the user may be informed and process 800 may return to operation 804 to display the message list.

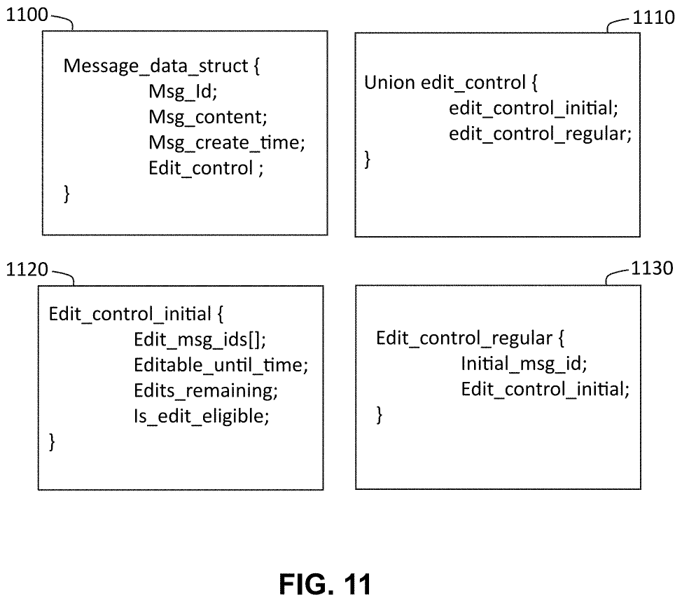

If the determination at operation 808 determines that the message is eligible to be edited, then at operation 810 a second message is generated for the purpose of providing an edit or clarification of the selected message. Generating the second message may include creating, in the memory of the user device, a data structure for the second message. For example, the generation of the second message may be initiated by calling a function to create a message and passing to that function the message identifier of the to be edited message. In some embodiments, the message data structure of the initial message in a chain of edits includes an array of message ids for recording the message identifiers of each of the subsequent versions of the message. The data structures of each of the subsequent versions contains a previous message id attribute that may point back to the initial message. In some embodiments, other parameters such as, for example, input parameters including values for one or more edit control attributes, can also be passed to the function to create the message data structure. An example message data structure 1100 that can be used for the second message is shown in FIG. 11. Note that in some example embodiments, the client device may not communicate with the server with respect to operations 808-810, and the operations 808-810 may be completed by the client device based on the information already included in the message list by the server. If any changes to the edit eligibility of a message in the message list occurs between the time of the message list's loading by the client device and the user sending an edit (for example, another edit was made from a different client device) the server may return an error message when the user attempts to send the edit (such as at operations 818-820).

At operation 812, the user device enables the user to edit the selected message by composing the second message. In some embodiments, in response to the edit eligibility determination at operation 810, an edit screen such as that shown in FIG. 3A or 3B may be provided to the user. The edit screen may be populated with a copy, or some portion, of the body of the selected message that is to be edited or clarified. A composer module may implement reloading fields from an application programming interface (API) to the selected message into their respective composer fields. Special considerations may be implemented to support media and other message objects that may or may not be editable. Other characteristics of the selected message, such as, for example, the target receivers of the message, the group of users enabled to reply to the message, attachments, etc. may also be copied from the selected message to the second message by default, and enabled for modification by the user.

The user is enabled to enter input to edit the second message. In some embodiments, there may be no restrictions imposed on the type or content of the second message. However, in some embodiments, certain restrictions may be enforced on the user input received for the second message. Such restrictions may include, but may not be limited to, preventing the changing of attachments other than to remove or add attachments, and preventing the changing of the target group of receivers.

The user may be informed, within the edit window, of the amount of time they have remaining to edit. In some embodiments, an edit timer may be implemented when a user opens the edit window. In some embodiments, a character/word count may be implemented in the edit window for a message edit. The remaining time and/or remaining characters/words may be dynamically announced/displayed when the composer is being used by the user.

In some embodiments, the time remaining to edit is based on a frontend timer implemented by the user device and attached to the selected message. For example, the timer may be associated, in the memory of the user device, with the data structure of the selected message and/or the second message. The timer may be set to a preconfigured value (e.g. 30 minutes, 1 hour) when the user selects the message for editing.

When the editing input has been completed, the user can press on a button (e.g. “update” button 310 in FIG. 3A) to submit the edit.

At operation 814, the user device receives an input from the user indicating that the editing input has completed. For example, the user may select a button indicating that the edit process is cancelled. If cancellation is indicated by the user, then any edits that are in process may be abandoned and process 800 may return to operation 804 to display the message list.

On the other hand, the user may select a button such as update button 310 (shown in FIGS. 3A and 3B) to command the edit to be posted. That is, pressing the update button 310 indicates to the user device that the second message is to be submitted as an edit to the selected message. If the user indicates, at operation 814, that the edits are to be submitted, then at operation 816, the populating of the data structure for the second message is completed and the data structure of the selected message (i.e. the first message) is updated to indicate that the selected message is now an edited message. For example, in some embodiments, the message data structure for the second message may be identical to the message data structure of the selected message except in the message content (body of the message and attachments) which has been modified, and the indications in the second message that it is an editing message and in the first message (the selected message) that it is an edited message.

At operation 818, the second message and at least an indication of the change of status of the selected message to being an edited message are transmitted from the user device to one or more servers of the messaging system. In some embodiments, the message data structure for the second message and the updated message data structure for the first message are transmitted to the server. In some embodiments the content in the second message may be modified prior to transmission in order to convey formatting etc. In some embodiments, validations may be performed on one or more fields of the second message data structure to ensure that they have not been edited.

At operation 820, a response may be received from the one or more servers acknowledging the edit operation. In some embodiments, an updated message list may be received from the one or more servers, where the updated message list includes the second message and also indicates that the first message is now an edited message.

At operation 822, the message list is redisplayed and the redisplayed message list includes the second message and also indicates the first message as having been edited by, for example, including an indicator with the first message to indicate that a more recent version of the message is available.

If certain predetermined criteria for a message to be editable is fulfilled by the second message, the second message may be displayed with an indication that the message is editable. For example, the second message may be displayed as a message in the message list along with an indicator indicating that the second message is editable. In some embodiments, a menu associated with each displayed message may be such that if the user clicks on the menu then any editable message would have a selectable “Edit” action displayed and any non-editable message would not have such an option.

In some embodiments, an edit history indicator may be associated with the first message and/or the second message. Upon selection of the edit history indicator associated with either of the first or second message by the user, details of the current version of the message and details of each previous version may be displayed. FIGS. 5 and 7 show examples of displayed edit history.

FIGS. 6A-6D show examples of message details displayed to the user, of edited messages that are selected for viewing from a message list where the edited messages are included in the viewing user's (the user of the user device 104a) message list because, for example, the edited messages were engaged with (e.g. liked, forwarded, quoted, or replied to, etc.) by a user who is associated with the viewing user. In each instance, a selectable visual indicator is displayed with the edited message, and upon selection of the visual indicator by the viewing user, the latest corresponding message or the edit history of the message may be displayed.

FIG. 9A illustrates a flowchart of a process 900 for creating the message data structure for an editing message according to some embodiments. For example, process 900 may be performed to generate the message data structure for the second message in operation 810 of process 800.

At operation 902, a message data structure is instantiated. An example message data structure 1100 is shown in FIG. 11. When process 800 is being executed on the user device, the message data structure for the second message is instantiated in the memory of the user device and then populated.

At operation 904, the second message is associated with the first message to indicate that the second message is a new version of the first message. In some embodiments, the second message is populated with information indicating that the first message (identified by its message identifier) is the previous version of the second message, and the first message is populated with information indicating that the second message (identified by its message identifier) is the next version first message. In some embodiments, the message data structure of the initial message in the chain of edited message versions includes an ordered list of message ids of each version of the message in time order. In such embodiments, the second message may point to (e.g., includes the message id of) the initial message as the previous message. In some embodiments, with respect to a particular message, the corresponding edited messages and the editing message each may include in the respective data structure (a) a pointer to the initial message and (b) a time-ordered list of all message ids in the edit chain (including the initial message and the latest version). In some embodiments, the message ids themselves may encode approximate creation time of the ids (and hence associated messages), so the ids can be trivially ordered by value and that order will reflect message creation time order (e.g., ascending order). In some embodiments, a separate pointer to the previous message (e.g., message id of the immediately preceding edited message) may not be separately maintained in the data structure, but may be inferred based on the list of message ids and the message id of the current message.

In some embodiments, servers 110 and user devices 104, may communicate in order to ensure that, if a user clicks through a stale message that has become stale after the corresponding message list was received at the user device from the server, the user is shown that the message is stale. In some embodiments, the server may track messages that have been recently served in message lists to user devices so that, if a message is subsequently edited, then its edits are also served to those message lists. For example, records detailing the messages sent to each device type for each user may be stored in a server-side database. When a user device requests a message list which is known to the server to be of a type which is cached on the user device, these records are used to provide a list of messages which may be still cached there based on the known cache size of the user device. The list can be further limited in scope according to the length of the edit window and the last time that message list type was requested for the client type in question. The resulting list may be checked against a cache of known edited messages. Thereafter, those messages which are found to have been edited are used to generate update instructions which are included in the user device's original message list response. For user devices that do not cache message lists, stale messages are filtered out upon read of the message list.

FIG. 9B illustrates a flowchart of a process 910 for displaying various edit statuses for messages according to some embodiments. In some embodiments, process 910 may be performed during operations 804 and/or 822 of process 800 to display or redisplay the message list.

At operation 912, it is determined if a message is an edited message, editing message or an editable message that is not an editing message. This determination can be made based on the message's data structure. For example, if the data structure includes a message id of a next version message, then the message is an edited message. If the data structure does not identify a next version message, then if the editable time window for the message has expired, then the message is an editing message that is not editable, otherwise the message is an editing message that is editable.

At operation 914, suitable edit indicators are displayed in accordance with the edit status of the message determined at operation 912. Edited messages are displayed with an indicator representing that the messages are edited, and a link to the latest version. For example, FIGS. 6A-6D and also FIG. 4A (e.g., message 402) show examples of edited messages which are not authored by the viewing user. FIG. 2 shows examples of edited messages (e.g., messages 210, 204 etc.) and editing messages (e.g. message 218) authored by the viewing user. Editing messages can be identified by an edit indicator (e.g., indicator 218). If the user is the author of the editing message and the editing time window has not expired, selecting/clicking the indicator may open an edit window to enable composing an edit and/or display the edit history. If the user is not the author of the editing message, then selecting/clicking on the edit indicator may display the edit history.

FIG. 9C illustrates a flowchart of a process 920 for controlling the edit capability based on a timer according to some embodiments. In some embodiments, process 920 may be performed during operations 806-812 of process 800.

At operation 922, a timer is associated with one or more messages in the message list. In some embodiments, a respective timer is associated with each message for which the time elapsed between the current time and the time of origination of the message is less than a preconfigured threshold (i.e. the edit time window has not expired). Each timer may be initialized to the remaining time to the preconfigured threshold.

In some embodiments, a user is authorized to edit only messages that are authored by the user, and therefore only messages that are authored by the user are associated with a timer for timing the edit window. In some embodiments, one or more criteria may be considered to determine edit eligibility, and timers are associated with only messages that satisfy the edit eligibility criteria.

Operation 924 monitors the respective timers continuously or at regular intervals, and controls display of edit eligibility indicia in accordance with the respective timer. For example, the edit eligibility for a message in the message list is displayed when the associated timer indicates a time elapsed that is below the threshold, and is not displayed when the associated timer indicates a time elapsed that is above the threshold.

FIG. 9D illustrates a flowchart for a process 930 for determining of the eligibility of a message to be edited according to some embodiments. In some embodiments, process 930 can be used during operation 808 of process 800. In some embodiments, one or more operations 932-944 may not be performed, or may be performed in an order different from the illustrated order.

At operation 932, it is determined whether the edit message feature is enabled. This may be a configuration parameter initialized at application startup.

At operation 934, it is determined whether the user is subscribed to a service level that includes the edit message feature. This may be a configuration parameter initialized at application startup.

At operation 936, it is determined whether the user is the author of the message. The message author may be determined from the message data structure.

At operation 938, it is determined whether the message is edit eligible. In some embodiments, one or more types of messages, for example, poll messages, are not permitted to be edited. When the message is created, the message data structure may be set to indicate whether or not the message is edit eligible, for example, based on the type of message.

At operation 940, it is determined whether the message has been previously edited. In some embodiments, the user is not permitted to edit any messages that have already been edited.

At operation 942, it is determined whether the time elapsed from the message posted time is within a preconfigured time window (i.e. that the edit time window has not expired). This determination may be based on the message's origination timestamp, the current time, and the edit time window setting.

At operation 944, in some embodiments, when the message has been previously edited, this operation determines whether the number of versions of the message is below a preconfigured threshold. This determination may be based on a configuration parameter defining the maximum number of edits (versions) for a message. In some embodiments, the message data structure may include an edit count attribute that is incremented each time a new version is generated due to an edit. In some other embodiments, the count may be inferred/calculated from a list of message ids maintained in the message data structure of the respective messages in the edit chain.

According to some embodiments, the message is considered eligible to be edited 946 if each of the determinations 932-944 is successful. If any of the determinations 932-944 is not successful, then the edit operation for the message is disallowed 948. In some other embodiments, the editability of a message may be determined without performing one or more operations 932-944 (for example, and without limitation, some embodiments may not include an option to subscribe to an editing capability and thus an operation 934 may not be present in such embodiments).

In respective embodiments, none, any one or more of the determinations 932-944 may be used to make the final determination regarding the message's eligibility to be edited.

In an embodiment, a post-editActions( ) function or the like may be provided. Such a function may be invoked when a user attempts to edit a message, and may return a value indicating whether the edit can be performed by the user, whether the user is not allowed to edit (e.g., user is not author or is not otherwise authorized to edit the message), whether the user attempted to edit a message that is not the latest post for that message, whether the edit time limit has been reached, or whether the edit count limit is reached.

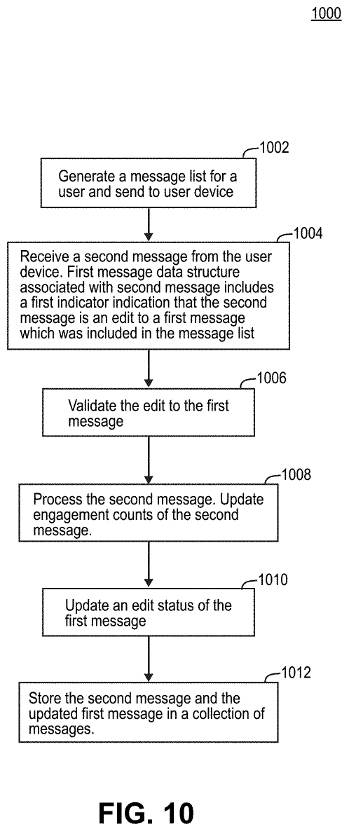

FIG. 10 illustrates a flowchart of a process 1000 for an edit capability by at least one server in a messaging system of FIG. 1 according to some embodiments. In some embodiments, process 1000 may be performed by at least one server 110a-110m of messaging system 100, to enable a user on a user device 104a to edit messages.

At operation 1002, a message list is generated for a user. For example, the message list may be generated by the messaging system's servers for the user of user device 104a. As described above, the messaging list may include some portion of the messages in the user's message stream, may include messages authored by the user and messages authored by other users of the messaging systems. The generated message list is transmitted to a user device of the messaging system.

At operation 1004, a second message is received from the user device, where the second message is an edit to another message (first message) that was included in the message list. The second message may be in the form of a message data structure, and the message data structure may include values indicating that the second message is an edit to the first message. The data structure that stores the first message includes an indication that the first message has a more recent version. In some embodiments, the second message is incorporated to one or more of the relationship graphs of the messaging system in the same manner, or similar manner, as the corresponding first message.

At operation 1006, the edit to the first message is verified. The verifying may include performing process 930 or some of the determinations specified in process 930. In some embodiments, the verification by the server may include determining whether the edit is within the edit time window. This determination at the server may include a buffer time period added to the configured time window. For example, whereas the configured time interval is 30 minutes (corresponding to the edit window timer implemented at the user device) for edit eligibility to be enabled, the server may add a buffer of 5 minutes or the like to reduce the impact of transmission delays and/or processing delays in between the message being processed in the user device and the time it is processed in a second in messages reaching the server. The timing may be based on monitoring a backend timer associated with the first message. If the backend timer expires before the update of the first message is completed, any portions of the update already made are reversed (this may require refreshing the message list or at least the affected messages stored or cached on the user device) and the user may be informed via a client application on the user device that the update failed.

At operation 1008, the second message is processed. The processing, in some embodiments, includes updating engagement counts of the second message. Each message may have its own set of counts for one or more types of engagements with that message. Additionally, an editing message may have a set of aggregated counts for the one or more types of engagements which will be determined by summing the counts of each of the corresponding message versions.

At operation 1010, an edit status of the first message is updated. In some embodiments, operations 1006-1010 may be performed in an order different from that shown.

At operation 1012, the second message and the updated first message is stored in a collection of messages. In some embodiments, the second message is stored separately from other stored messages, in a storage area for message data structures of messages that are still within the editable time window. The message data structures stored in this editable structure storage area may be moved to be stored with other messages upon expiry of the editable time window for the respective messages or upon the respective messages becoming edited messages. In some embodiments, only the message ids (but not the message data) of the editable messages may be stored separately. Separately storing editable messages may provide for faster edits and/or faster retrieval of messages associated with edit.

Subsequent to the edit being stored at the servers, edited posts may fan out to all systems. For example, on Twitter, edited Tweets may fan out to all systems within twitter like normal tweets.

Subsequently, when the at least one server of the messaging system generates (e.g., by content generation engine 112a) message lists to be provided to various user devices, a visibility filtering capability may be used to limit visibility of stale messages on various user-facing interfaces of the messaging system as appropriate. Stale messages cached on user devices may be removed via instructions from the server or the like. In addition engagements (e.g., in Twitter, likes, reply, quotes, retweets) may be disabled on stale messages.

FIG. 11 illustrates an example message data structure 1100 used for a message edit capability in a messaging system of FIG. 1 according to some embodiments.

A message data structure 1100 may be instantiated for each message. The message data structure 1100 may include attributes message id (msg_id), message content (msg_content), message create time (msg_create_time), message author (msg_author), and other attributes descriptive of aspects of the message. The message id attribute contains a unique identifier for the message. The message content attribute contains the body of the message. The create time attribute contains the timestamp of the message origination. This timestamp may be provided by the server-side process when the message is initially posted to the messaging system. The author attribute specifies the user id of the author of the message.

With respect to the edit capability, according to some embodiments, the message data structure may further include an edit control data structure 1110 which stores the information required for the edit capability. The edit control data structure 1110 may be formed as a union of an edit control initial data structure 1120 and an edit control regular data structure 1130. The two types of data structures, edit control initial data structure 1120 and edit control regular data structure 1130, are configured so that every edit chain has a single source of truth for the list of edits and other editability data (in the edit_control_initial) which can then be accessed at read time from any of the edits (e.g., by copying over the edit_control_initial to the edit_control_regular at read time, requiring a single extra lookup for the list, as opposed to either duplicating the information which could lead to inconsistencies, or requiring a traversal of the edit chain message-by-message).

In an example embodiment, all new messages that are not created as editing messages are stored as new messages with an edit control initial data structure 1120 which is configured to store information regarding the editability of the message and the full list of ids of edits of the initial message. Messages created as editing messages are stored as new messages with an edit control regular data structure 1130 which stores a pointer to the corresponding initial message. The two data structures edit control initial and edit control regular may be formed as a union structure, and the union structure may be an attribute of the message data structure for the message. This configuration minimizes the data duplication and provides for efficiently handling a large volume of edits.

The edit control initial data structure 1120 includes a list of message ids (edit_msg_ids) for all the versions of the message, an editable until time attribute (editable_until_time) that specifies the expiration of the editable time window, an edits remaining attribute (edits_remaining) that keeps track of the maximum number of edits allowed, and an edit eligible attribute (is_edit_eligible) that is set to false if the message is not eligible to be edited and to true otherwise. The list of message ids is a list of all edits of the initial message including the initial message's id, and may be arranged in ascending time order. The editable until time attribute may be set to a value that is obtained by adding a preconfigured edit time window to the create time of the message. The edits remaining attribute may be initialized to the preconfigured maximum number of edits, and may count down when the message id for a new edit is added to the list of message ids. When the edits remaining reaches 0, no more edits are permitted. The edit eligible attribute may be initialized based on criteria (rules) such as whether the messaging application is configured to allow for edits, whether the author's subscription or privilege level allows for edits, etc. Subsequently, the attribute value may be updated based on whether the message becomes uneditable due to, for example, expiration of the editable time window, reaching the maximum number of edits, whether the message becomes an edited message, etc.

The edit control regular data structure 1130 includes an initial message id attribute which contains the id of the initial message in the edit chain. This data structure may also optionally include an edit control initial data structure that can be used to populate the edit control data structure of the editing message based on the message being edited and/or to provide more efficient access of the list of edits/editability information.

In some example embodiments, when a message in an edit chain is requested (e.g., content generation for a message list, etc.), the one or more servers of the messaging system may populate edit control initial attribute in the edit control regular data structure so that a read of any version of the message will be provided with the full data about edits and editability of the message.

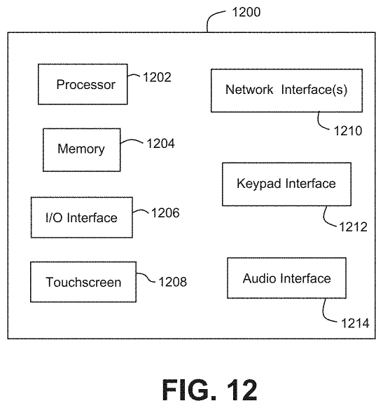

FIG. 12 illustrates an example user device 104 according to one or more aspects described herein. User device 104 may include one or more hardware and/or software components, such as processor 1202, memory 1204, input/output interface 1206, touch sensitive display 1208, network interface 1210, keypad interface 1212, and audio interface 1214. By including one or more of these and/or other components, user device 104 may be used as a desktop computer, laptop computer, server, tablet computer, netbook, cellular phone, mobile computing device, and/or the like. In at least one arrangement, user device 104 may include a plurality of one or more of the components described herein. For instance, in at least one arrangement, user device 104 may include two or more processors.

In one or more arrangements, processor 1202 may execute computer-executable and/or computer-readable instructions stored in memory 1204. For instance, processor 1202 may execute instructions that cause one or more of the methods described herein to be performed by user device 104. Additionally or alternatively, processor 1202 may execute instructions that cause one or more user interfaces (e.g., message composer) described herein to be displayed on a display included in user device 104, such as touch sensitive display 1208.

In one or more arrangements, touch sensitive display 1208 (also referred to as “touchscreen”) may comprise an electronic visual display (e.g., a liquid crystal display (“LCD”) screen, a plasma display panel (“PDP”), a cathode ray tube (“CRT”) display, a light emitting diode (“LED”) display, and/or an organic light emitting diode (“OLED”) display). Touch sensitive display 1208 may respond to touch-based user input and thus may function as a “touch screen” display. Touch sensitive display 1208 may implement one or more touch sensing technologies (e.g., resistive, surface acoustic wave, capacitive, strain gauge, optical imaging, dispersive signal technology, acoustic pulse recognition, coded LCD, etc.).

In one or more arrangements, input/output interface 1206 may include one or more adapters, connection ports, and other components via which user device 104 may provide input and output. For instance, input/output interface 1206 may include one or more adapters for outputting data to and/or receiving data from a display (e.g., for providing audiovisual, graphical, and/or textual output), keypad, microphone, mouse, optical reader, scanner, speaker (e.g., for providing audio output), stylus, touch screen, and/or other component. Input/output interface 1206 further may include a USB port, serial port, parallel port, IEEE 1394/Firewire port, APPLE iPod Dock port, and/or other ports.

In one or more arrangements, network interface 1210 may establish and/or provide network connectivity to a network (e.g., a local area network, a wide area network, such as the Internet, etc.). Network interface 1210 thus may include hardware and/or software components for communicating via Ethernet, TCP/IP, FTP, HTTP, HTTPS, and/or other protocols. The network interface 1210 may additionally or alternatively establish and/or provide network connectivity to a wireless network (e.g., a local area network, a wide area network, such as the Internet, a cellular voice and/or data network, etc.). Wireless interface 1212 thus may include hardware and/or software components for communicating via Ethernet, TCP/IP, FTP, HTTP, HTTPS, IEEE 802.11b/g/a/n, Bluetooth, CDMA, TDMA, GSM and/or other protocols.

In one or more arrangements, keypad interface 1212 may include one or more physical keys, buttons, and/or switches that may be operated to provide input to and/or control various aspects of user device 104. Audio interface 1214 may include one or more speakers, audio ports (e.g., a headphone jack), microphones, and/or other audio components. Audio interface 1214 may allow user device 104 to provide audio feedback, receive audio input (e.g., sound input, speech commands, etc.), and/or provide telephone functionalities.

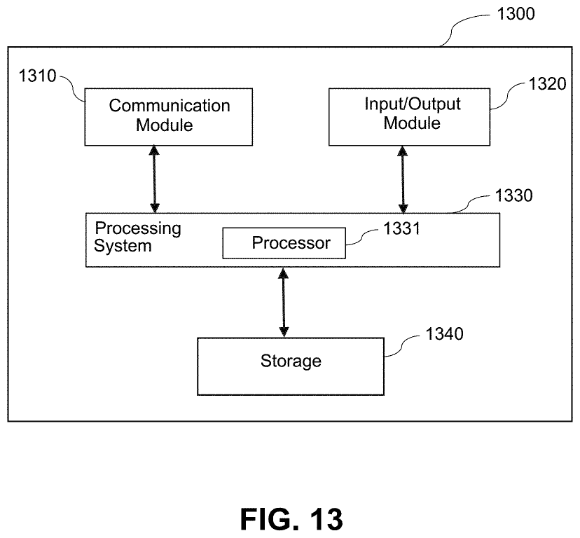

FIG. 13 illustrates a non-limiting, example block diagram for an example platform server 110. In this example embodiment, the server 110 includes a communication module 1310 including communication circuitry and circuitry (e.g., a transceiver), an input/output module 1320 including I/O circuits and circuitry, a processing system 1330 including a processor, and a storage 1340, all of which may be communicatively linked by a system bus, network, or other connection mechanisms.

The communication module 1310 functions to allow the server 110 to communicate with one or more of the other devices (e.g., user devices 104, other platform servers 110 or a global server). The communication module 1310 is configured to transmit data to other devices and/or receive data from other devices.

In certain example embodiments, the communication module 1310 may comprise one or more communication interfaces supporting satellite communications, radio communications, telephone communications, cellular communications, internet communications, and/or the like. In other example embodiments, the communication module 310 may comprise a wireless transceiver with connected antenna, a wireless LAN module, a radio-frequency (RF), Infrared, or Bluetooth® transceiver, and/or a near field communication transceiver module. One or more of these communication components may collectively provide a communication mechanism by which the server 110 can communicate with other devices, platform and/or networks.

The data storage 1340 may comprise one or more volatile and/or non-volatile storage components, such as, a hard disk, a magnetic disk, an optical disk, read only memory (ROM) and/or random access memory (RAM), and may include removable and/or non-removable components. The data storage 340 may be integrated in whole or in part with the processing system 1330.

The processing system 1330 may comprise one or more processors 1331, including one or more general purpose processors and/or one or more special purpose processors (i.e., DSPs, GPUs, FPs or ASICs). The processing system 1330 may be capable of executing application program instructions (e.g., compiled or non-compiled program and/or machine code) stored in data storage 1340 to perform any of the functions and processes described above. The data storage 1340 may include non-transitory computer-readable medium, having stored thereon program instructions that, if executed by the processing system 1330, cause the server 110 to perform any of the processes or functions disclosed herein and/or illustrated by the accompanying drawings.

In certain example embodiments, the program instructions stored in the storage 1340 may include an operating system program and one or more programs, such as program instructions for load balancers and the message-related features described herein.

The input/output module 1320 of the server 110 may enable the server 110 to interact with a human or non-human user, such as to receive input from a user and to provide output to the user. The input/output module 1320 may include a touch-sensitive or presence-sensitive panel, keypad, keyboard, trackball, joystick, microphone, still camera and/or video camera, and the like. The input/output module 1320 may also include one or more output components such as a display device, which may be combined with a touch-sensitive or presence-sensitive panel. In an example embodiment, the input/output module 1320 may display various user interfaces to enable a user or an operator to access services or functions provided by the server 110.

While the disclosed technology has been described in connection with what is presently considered to be the most practical and preferred embodiments, it is to be understood that the systems and method described herein are not to be limited to the disclosed embodiments, but on the contrary, are intended to cover various modifications and equivalent arrangements included within the spirit and scope of the appended claims.

What is claimed is:

1. A method comprising:
displaying, on a display of a client device in a messaging system, a message list comprising a plurality of messages, wherein the message list is received from at least one server of the messaging system;
receiving, by the client device, a selection input in association with a first message in the displayed message list;
determining, by the client device and based at least on a user identifier associated with the first message and on whether the first message is a previously edited message, whether the first message is editable;
in response to determining that the first message is editable, generating, by the client device, a second message in association with the first message;
displaying, by the client device, the second message for editing, the displayed second message providing content of the first message for editing;
receiving, by the client device, a signal indicating edit completion in association with the second message;
updating, by the client device, an edit status of the first message to indicate a previously edited message status; and
transmitting, by the client device, the second message and at least an indicator of the updating to the at least one server.

2. The method according to claim 1, wherein the generating a second message in association with the first message comprises forming a second message data structure for the second message and associating a first message data structure of the first message with the second data structure.

3. The method according to claim 1, further comprising, in response to receiving said signal, re-displaying the message list with the re-displayed message list including the first message and the second message as respective messages in the message list.

4. The method according to claim 3, wherein the redisplayed first message includes a first indicator that it has been edited and the redisplayed second message includes a second indicator that it has one or more previous versions.

5. The method according to claim 3, further comprising displaying a selectable indicia in at least one of the redisplayed first message or the second message to display edit history of the first message or the second message.

6. The method according to claim 1, wherein the displaying a message list comprising a plurality of messages comprises:
determining one or more messages that are eligible to be edited; and
displaying an indicia of edit eligibility in association with each of the one or more messages.

7. The method according to claim 6, wherein the first message is one of the one or more messages that are eligible to be edited and the received selection input comprises an input associated with the indicia of edit eligibility.

8. The method according to claim 6, further comprising:
associating a respective timer with each of the one or more messages that are eligible to be edited; and
controlling the displaying of the indicia of edit eligibility of each of the one or more messages in accordance with the corresponding associated respective timer.

9. The method according to claim 8, wherein controlling the displaying of the indicia of edit eligibility of each of the one or more messages in accordance with the corresponding associated respective timer comprises displaying the indicia only when a value of the respective timer is less than a threshold.

10. The method according to claim 1, wherein the determining one or more messages that are eligible to be edited is based at least on an user identifier associated with the first message and a previous edited status of the first message.

11. The method according to claim 10, wherein the determining one or more messages that are eligible to be edited is based further on at least one of a timer associated with the first message, a type of the first message, a privilege level of a user associated with the first message.

12. The method according to claim 1, wherein the displaying the second message for editing, the displayed second message providing content of the first message for editing comprises controlling the displaying of the second message for editing in accordance with a timer based on a timestamp of the first message.

13. The method according to claim 1, wherein the at least one processor is programmed with instructions that cause the messaging system client device to perform further operations comprising: in response to receiving the selection input, verifying eligibility of requested edit operation before said generating and displaying.

14. The method according to claim 13, wherein the verifying eligibility comprises at least one of checking whether user is author of the first message, checking whether the user is authorized to edit, checking whether the first message is an editable message, and checking whether a predetermined expiration time window has expired.

15. The method according to claim 1, wherein the at least one processor is programmed with instructions that cause the messaging system client device to perform further operations comprising:
disabling engagements for the first message.

16. The method according to claim 1, wherein the at least one processor is programmed with instructions that cause the messaging system client device to perform further operations comprising:
aggregating engagements for the second message.

17. A messaging system server device comprising at least one processor and a memory, the at least one processor programmed with instructions that cause the messaging system server device to perform operations comprising:
receiving a second message from a client device, wherein a message data structure associated with the second message includes a first indicator indicating that the second message is an edit to a first message;
validating the edit to the first message;
processing the second message, the processing including updating an engagement count of the second message based on engagements of the second message and engagements of the first message;
updating an edit status of the first message; and
storing the second message and the updated first message in a collection of messages.

18. The messaging system server device according to claim 17, wherein processing the second message further includes associating a timer with the second message to control an editable duration of the second message.

19. The messaging system server device according to claim 17, wherein the at least one processor is programmed with instructions that cause the messaging system server device to perform further operations comprising:
in response to a received request, generating a message list including the second message and the first message, wherein the message data structure includes a first indicator indicating that the second message includes an edit to the first message and a second message data structure includes a second indicator indicating that a later version exists for the first message.

20. The messaging system server device according to claim 17, wherein the message list further comprises one or more non-editable messages.

21. A method performed by a messaging system server device, the method comprising:
receiving a second message from a client device, wherein a message data structure associated with the second message includes a first indicator indicating that the second message is an edit to a first message;
validating the edit to the first message;
processing the second message, the processing including updating an engagement count of the second message based on engagements of the second message and engagements of the first message;
updating an edit status of the first message; and
storing the second message and the updated first message in a collection of messages.

22. A messaging system client device comprising at least one processor and a memory, the at least one processor being programmed with instructions that cause the messaging system client device perform operations comprising:
receiving, from a server device, a message list including a first message and a second message, wherein a first data structure associated with the first message includes and indicator indicating that the first message includes an edit of the second message and a second data structure associated with the second message indicates that the second message has been edited; and
displaying the message list, wherein the displaying includes, in a display element associated with the first message or the second message, indicating an association with the other of the first message or the second message in a manner that differs for respective types of messages.
